(19) United States
(12) Patent Application Publication
(10) Pub. No.: US 2022/0158986 A1
(43) Pub. Date: May 19, 2022

(54) NON-STORED MULTIPLE FACTOR VERIFICATION

(71) Applicant: Titaniam, Inc., Los Gatos, CA (US)

(72) Inventors: Arti Raman, Los Gatos, CA (US); Nikita Raman, Los Gatos, CA (US)

(21) Appl. No.: 16/950,404

(22) Filed: Nov. 17, 2020

(51) Int. Cl. H04L 29/06

(52) U.S. Cl. CPC H04L 63/083; H04L 2463/082; H04L 63/20; H04L 63/0861

(57) ABSTRACT

A method for authenticating users without the need to store factors within the authentication system is provided. For example, the method includes receiving a currently provided first identity factor from a user and generating a matrix of values from the currently provided first identity factor. The method further includes accessing a stored user algorithm for the user and generating an unverified second identity factor. The method also includes receiving a currently provided second identity factor from the user and determining whether the unverified second identity factor matches the currently provided second identity factor.

### TECHNICAL FIELD

This disclosure relates generally to user factor verification, and, in particular, to multiple factor verification without storing any factors in storage.

### BACKGROUND

Humans depend on computer systems for many tasks in their personal and professional lives. A basic requirement that falls out of this is the need for users to identify themselves to these systems. Over the years, this has developed into the rich field of Identity and Access Management (IAM).

However, one of the risks created by the IAM field itself is that in order to be able to identify users to the system, an authentication system must maintain a list of users and valid credentials within the system itself. This list has become the target of many attacks since the compromise of this list provides access to the accounts of all the users on the system. Once those accounts are compromised, sensitive data can be stolen. Many data breaches begin with the compromise of valid credentials.

Current technologies require that one or more factors, such as a password, biometric information, etc., be stored at the authentication system in order to verify the user provided factor with the stored factor. While certain factors such as passwords can be hashed, other factors such as biometric data cannot be hashed because different scans of biometric data of the same person may vary slightly, resulting in mismatched hashes if hashes of these different scans were compared. Instead, biometric data may be converted to a template or mapping, which, if compromised, can be used to generate an imitation biometric input that can create the same template or mapping to allow access to a system. Thus, any compromise of these systems will cause these factors, or the sensitive hashes or templates generated from these factors, to be leaked to malicious users. Unlike certain factors such as passwords, factors that are inherent to the user, such as biometrics or personal information, also cannot be changed and thus the leakage of information related to these factors can render them inoperable for future use.

Therefore, what is lacking is a method of authenticating users without the need to store factors within the authentication system or anywhere else and without a means of recovering any factors using information stored in the authentication system.

### SUMMARY

Systems, methods, and/or computer program products (e.g., a non-transitory computer readable storage media that stores instructions executable by one or more processing units) for a system for authenticating users without the need to store factors within the authentication system is provided. In one embodiment, an authentication system receives a currently provided first factor from a user. The currently provided first factor is a user authentication factor, such as a password, biometric data, etc. The authentication system generates a matrix of values from the currently provided first factor using a one way function. Subsequently, the system accesses a stored user algorithm for the user and generates an unverified second identity factor. Further the system receives a currently provided second identity factor from the user and determines whether the unverified second identity factor matches the currently provided second identity factor.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates an example system for multiple factor authentication without storing any factors, in accordance with an embodiment.

FIG. 2 is an example of a method to geometrically generate a rotated cube matrix used to derive the coordinate values for the user algorithm based on user provided factors, in accordance with an embodiment.

FIG. 3 illustrates an example of user registration using the method described herein, in accordance with an embodiment.

FIG. 4 illustrates an example of a proper user authentication using the method described herein, in accordance with an embodiment.

FIG. 5 illustrates an example of a failed authentication due to an invalid username using the method described herein, in accordance with an embodiment.

FIG. 6 illustrates an example of a failed authentication due to an invalid factor using the method described herein, in accordance with an embodiment.

FIG. 7 illustrates an example of a failed authentication due to an invalid second factor using the method described herein, in accordance with an embodiment.

FIG. 8 is a flow diagram illustrating a process for multiple factor authentication without storing any factors, in accordance with an embodiment.

FIG. 9 is a block diagram illustrating components of an example machine able to read instructions from a machine-readable medium and execute them in a processor or controller, according to an embodiment.

### DETAILED DESCRIPTION

The Figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed by way of example embodiments are systems, methods and/or computer program products (e.g., a non-transitory computer readable storage media that stores instructions executable by one or more processing units) for a system for multiple factor authentication without storing any factors. In one embodiment, an authentication system receives a currently provided first factor from a user. The currently provided first factor is a user authentication factor, such as a password, biometric data, etc. The authentication system generates a matrix of values from the currently provided first factor using a one way function. The one way function may, using the currently provided first authentication factor, generate a series of rotations for a cube (i.e., a set of matrices resembling the faces of a cube) that allows for maximum entropy in the resulting rotated cube. The rotated cube is represented as the matrix of values (e.g., the matrix may represent the various faces of the rotated cube).

The authentication system subsequently accesses a stored user algorithm for the user. The stored user algorithm is previously generated during a registration phase by comparing 1) an application of a non-stored verified second authentication factor to a non-stored verified matrix of values with 2) an application of a non-stored verified first authentication factor to the non-stored verified matrix of values. The non-stored verified matrix of values generated from the non-stored verified first authentication factor using the one way function during the registration phase. In one embodiment, the application of an authentication factor to a matrix of values results in the generation of coordinate values indicating the coordinate location of the values of the authentication factor within the matrix of values. Thus, the stored user algorithm may indicate a difference generated when comparing the coordinate values of the first and second authentication factors on the matrix of values.

The authentication system generates an unverified second authentication factor by applying the stored user algorithm to an application of the currently provided first authentication factor to the matrix of values. In one embodiment, the authentication system achieves this by reversing the process performed during registration, using the stored user algorithm to generate a second authentication factor based on the currently provided first authentication factor and the generated matrix of values. The authentication system also receives a currently provided second authentication factor from the user.

The authentication system subsequently compares the generated unverified second factor with the second factor that is currently provided by the user. If a match is found, then a message is transmitted indicating the user is authenticated. Otherwise, a message is sent indicating the user is not authenticated.

Optionally, the generation of the unverified second factor may be preceeded by the verification of a currently provided username. The authentication system may have previously generated a user key based on a username provided by the user during registration. The user algorithm may have been modified to include a comparison result between an application of the user key to the verified matrix of values and the other values within the user algorithm. The same method is used to generate an unverified user key using the currently provided username. This is compared with the user key that is extracted from the user algorithm to determine whether the provided username is the same as the username provided during registration. If username verification fails, then the generation of the unverified second factor may not occur, and transmission of a message indicating failure of authentication may occur.

In addition, the system may include additional factors, such as a factor that is presented to the user based on the comparison result to show that the system is trustworthy.

Using this system, neither of the factors (or username) provided by the user need to be stored at the authentication system for it to authenticate the user. The system described does not tie a user to a local device of the user which stores biometric or other factor information of the user in order to authenticate the user, and can be used with any user device. As the system only stores the user algorithm, which is linked to multiple authentication factors, unauthorized access of the user algorithm does not allow a malicious attacker to recover any of the authentication factors used to generate the user algorithm. Furthermore, the one way function ensures at least a threshold level of entropy when generating the matrix of values such that the original authentication factor cannot be easily recovered using only the matrix of values, while ensuring that the same matrix of values can be generated when presented with the same authentication factor identifying the same user. As the authentication factors cannot be recovered, authentication factors which are inalterable for the user, such as biometric information, will not be compromised and rendered useless for future use.

### Example System Environment

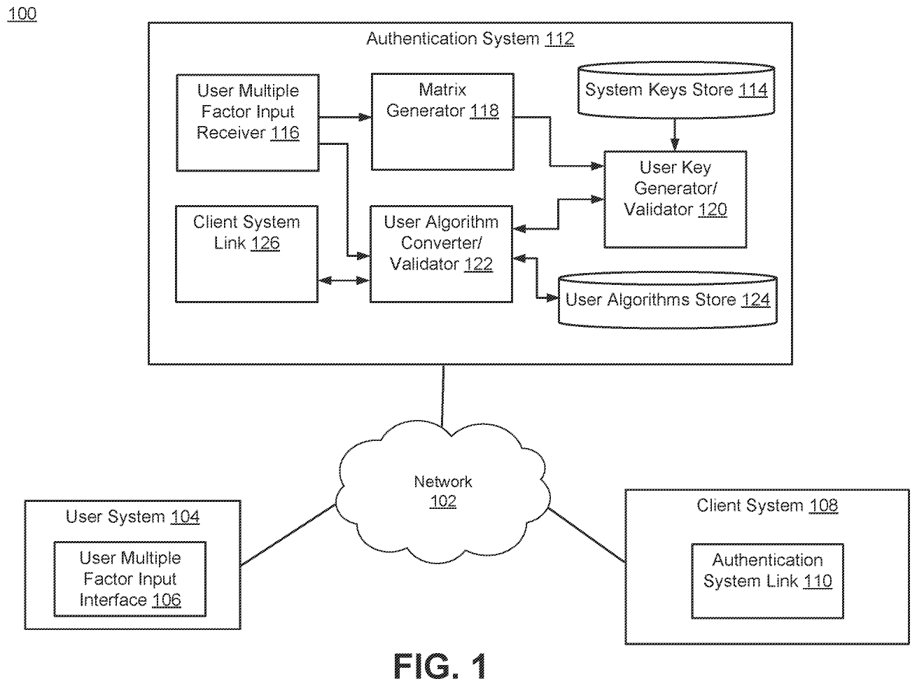

FIG. 1 illustrates an example system for multiple factor authentication without storing any factors, in accordance with an embodiment. The example system environment 100 shown in FIG. 1 may include an authentication system 112 with a user system 104 and a client system 108, connected via network 102. Although certain components are shown here, in other embodiments the functions of certain systems may be performed or shared with other systems, and the number of elements may differ. For example, there may be more than one user system 104 and more than one client system 108. As another example, the user algorithms store 124 may be stored in the client system 108.

The communications among the elements in the system 100 may be transmitted via the network 102, which may be, for example the Internet, a local area network, system bus, and so on. Some of the elements may communicate by one network, while other elements may communicate using a separate network. Each of these separate networks may be similar to the network 102. In one embodiment, the network 102 uses standard communications technologies and/or protocols. Thus, the network 102 can include links using technologies such as Ethernet, 702.11, direct microwave point to point connections, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 102 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 102 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the elements in the system 110 can use custom and/or dedicated data communications technologies instead of, or in addition to, the ones described above, such as a custom TCP/IP protocol.

The user system 104 includes one or more computing devices that may be operated by a user and be used by the user as a front-end device with which the user may be able to access data and other services offered by the client system 108. For example, the client system 108 may include one or more computer systems of an organization that can be accessed by the user system 104 upon authentication. Examples of user systems 104 include personal computers (PC), desktop computers, laptop computers, tablet computers, smartphone, wearable electronic devices such as smartwatches, or any other suitable electronic devices.

The user system 104 may include a user multiple factor input interface 106. This may be provided by the authentication system 112 and/or the client system 108, and may be in the form of an application partially or wholly executing on the user system 104, or other component such as a application executing remotely and presented in an application (e.g., a web browser) of the user system 104. The user multiple factor input interface 106 allows the user of the user system 104 to enter one or more authentication factors. Authentication factors include data that can be used to authenticate and/or identify the user and distinguish the user from other users. Authentication factors may be categorized into knowledge factors, possession factors, inherent factors, location factors, and device data.

Knowledge factors include information that the user is requested to prove that they know in order to authenticate. Examples of this type of factor are passwords, PINs and secret questions.

Possession factors include elements that the user has in their possession akin to having a physical key that opens a lock. Security tokens are examples of this type of factor. Security tokens can be disconnected (i.e., generated on an independent device and typed in by the user), connected (i.e., generated on a device that is connected, e.g. by USB and automatically read by the computer) or software-based (i.e., generated on an electronic device such as a mobile phone—and can be copied).

Inherent factors include data inherently associated with the user such as their biometrics. Examples of this type of factor are data that represent the user's fingerprints, facial features, voiceprint and iris features.

Location factors include information pertaining to the user's location. Some systems utilize a user's location to determine how many factors should be required for authentication. Location can also be used to permit or deny access based on where the user is located relative to where they are expected to be at the time.

Device data information includes information about the user's device (e.g., user system 104), which may be used to authenticate the user. For example, a cookie stored on the user's device, or a hash or other information about the hardware components of the user's device may be used to determine that the user is the same user that previously accessed the system.

Authentication factors may also include other environmental factors (e.g., geolocation, network address and other network information, device info) and behavioral factors (e.g., user browsing and device usage patterns, mouse movements, access patterns). In addition, one or more factors may be combined together into a single factor using any combining function (e.g., hashing, concatenation).

Some of the factors described above may be inputted via the user multiple factor input interface 106 directly by the user. For example, a password, PIN, or security token code may be entered directly by the user. Other factors may be inputted to the user multiple factor input interface 106 via an external device, such as a biometric scanner, smart card reader, security token interface device, etc. Other factors, such as location information or device information, may be inputted via an application programming interface (API) without action from the user.

In one embodiment, the user multiple factor input interface 106 also allows the user to input a unique username to the authentication system 112. This unique username allows the authentication system 112 to further prevent any collisions between two users, in the very rare event that their authentication factors are the same (e.g., in the case of twins having the same biometric information). The username is used as an additional identification method for the user in addition to any authentication factors.

The client system 108 includes one or more computing systems of an entity, such as a corporation or organization, that may be accessed by users of the user system 104. These computing systems may include web servers, databases, authentication systems, and other elements and resources belonging to the entity.

The client system 108 includes an authentication system link 110 which can communicate with the authentication system 112 in order to authenticate the user of the user system 104 when the user system wishes to access the computing systems of the client system 108. In one embodiment, when the client system 108 receives a request from the user system 104 to authenticate a user of the user system 104, the authentication system link 110 of the client system 108 communicates with the authentication system 112 to authenticate the user. The authentication system link 110 redirects the user to the authentication system 112 to input the multiple authentication factors (via the user multiple factor input interface 106) in order to authenticate the user. In another embodiment, the client system 108 receives the authentication factors from the user via the user multiple factor input interface 106 and subsequently transmits this information to the authentication system 112 via the authentication system link 110. The same processes may be used to transmit the authentication factors to the authentication system 112 when initially registering the user. After the authentication system 112 performs the authentication process, a response is received by the client system 108 via the authentication system link 110 indicating whether the authentication was valid or invalid, along with additional metadata, such as any reason for the authentication failure, etc.

The authentication system 112 authenticates a user of the user system 104 without storing a copy of any of the authentication factors which the user may provide during authentication. In one embodiment, the authentication system 112 includes a system keys store 114, a user multiple factor input receiver 116, a matrix generator 118, a user key generator/validator 120, a user algorithm converter/validator 122, a user algorithms store 124, and a client system link 126. However, in other embodiments, the authentication system 112 may include different elements from those listed here. In addition, some of the elements shown here may be performed by other elements in the environment 100, such as by the client system 108.

The system keys store 114 is a store that includes a list of unique keys. These unique keys may be generated using a hash function, a counter, or any other method of generating numeric or alphanumeric strings of values. The system keys store 114 may have a sufficient number of keys to ensure a level of randomness in the generation of the user keys, as described below.

The user multiple factor input receiver 116 receives the authentication factors (and optionally the username of the user) from the user, either directly via the user system 104 or the client system 108. During registration of the user, the user multiple factor input receiver 116 may initially receive verified authentication factors for the user. These authentication factors are verified because they are the initial authentication factors used to register the user. The user multiple factor input receiver 116 sends these initial verified authentication factors to the matrix generator 118 and the user algorithm converter/validator 112. In one embodiment, a first authentication factor is sent to the matrix generator 118 to generate one or more rotated cube matrices, and the first and additional authentication factors are sent to the user algorithm converter/validator 122 to generate the user algorithm for the user that is stored in the user algorithms store 124.

During authentication of a user, the user multiple factor input receiver 116 receives a first authentication factor that is currently provided by the user, which it sends to the matrix generator 118. The user multiple factor input receiver 116 may also receive a second authentication factor that is currently provided by the user, which may be sent to the user algorithm converter/validator 112 along with the first authentication factor to validate against a generated second factor that is generated using the stored user algorithm for the user. As noted, if a match is found, the user is determined by the authentication system 112 to be validated.

In one embodiment, the user multiple factor input receiver 116 may also receive a username provided by the user. This may be transmitted to the user key/generator validator 120 to generate a user key for the user during registration.

In another embodiment, the user multiple factor input receiver 116 may receive additional authentication factors. These may also be used to validate against authentication factors generated by the user algorithm converter/validator 122. In another embodiment, the user multiple factor input receiver 116 may receive a generated authentication factor from the user algorithm converter/validator 122, and may transmit this to the user system 104 to allow the user of the user system 104 to validate against an authentication factor known to the user. This allows the user to know that the authentication system 112 is trustworthy.

In one embodiment, the user multiple factor input receiver 116 may enforce a minimum level of complexity for the authentication factors that it receives. For example, a minimum length, character set usage, amount of data, entropy, and so on, may be required. If these requirements are not met, the user multiple factor input receiver 116 may reject the authentication factor.

The matrix generator 118 receives a first authentication factor from the user multiple factor input receiver 116 and generates one or more rotated cube matrices (i.e., matrices of values) using the first authentication factor via a one way function. The rotated cube matrices are not stored, but generated each time an authentication factor is received by the matrix generator 118. Furthermore, a user cannot recover the first authentication factor by only knowing the one or more rotated cube matrices and the one way function. Although the description here refers to the output of the matrix generator 118 as a rotated cube matrices, in other embodiments the output from the matrix generator 118 may be another format, such as an array of values, a vector, a function, and so on.

In one embodiment, the matrix generator 118 generates the rotated cube matrix by initializing a representation of a cube with a set of initial values. The cube has six different faces, and each face can include a set of initial values. Each face includes the same number of values. These initial values may be sequentially listed on the cube, or may be randomly arranged. However, so that the same rotated cube matrix is generated for each first authentication factor, the initial values for the cube should be generated to be the same each time by the matrix generator 118. In some cases, the matrix generator 118 may initialize the values on the representation of the cube using the first authentication factor, for example, by hashing or extracting characteristic values from the first authentication factor and using these values as a seed to generate the values in the representation of the cube. The cube may be of any size, such as a 7×7×7 cube.

Internally, the cube may be represented via a matrix, array, database table, or other store. For example, 7×7×7 cube may be represented by six different matrices, each having 7×7 (or 49 values).

After initializing the representation of the cube (or other object), the matrix generator 118 generates a set of rotation instructions to “rotate” the representation of the cube, resulting in a rotated cube. The cube is rotated as if it were a 3D combination puzzle (e.g., a Rubik's Cube), that includes multiple smaller cubes, or cubelets, which are arranged such that the form the larger cube of the puzzle. These cubelets have outwards facing surfaces, which are shaped as squares. In the representation of the cube, each outward facing surface is represented by a value in the representation of the cube. For example, if the cube were represented by a matrix, each value in the matrix represents one outwards facing surface of one of the cubelets of the cube. A rotation of the cube involves the rotation of a layer of cubelets, such that the outward facing surfaces of these cublets are either rotated around an axis but stay on the same face of the larger cube, or are moved to a different face of the larger cube. This can be represented in the representation of the cube by moving the values representing each surface to different parts of the representation. For example, if the cube is represented by a matrix, a rotation would cause the different values in the matrix to be moved to different positions to represent the rotation in the cube. The rotation instructions can be represented by indicating one of the faces of the cube as the front face, and having the instructions be rotations of the different layers of the cube in relation to the front face. This may be scaled to a cube of any dimension.

The matrix generator 118 generates the rotation instructions based on the first authentication factor that is received. In one embodiment, the matrix generator 118 may hash the first authentication factor using a hashing algorithm, and extract a number of values from the resulting hash to generate the rotation instructions. The first authentication factor may be further modified (e.g., via concatenation) before hashing by the username provided by the user during registration and/or user key as generated using the user key generator/validator 120 as described below. As there are a fixed number of possible rotation instructions available for the cube, a cipher can be generated that associates the values of the hash to different types of rotation instructions.

In one embodiment, the first authentication factor may be a biometric or other factor that may not have the exact same values each time they are measured. In such a case, the matrix generator 118 may extract various characteristic values from the authentication factor, or use a fuzzy hashing or locality sensitive hashing method to extract a set of values from the first authentication factor. These values should not change when generated using authentication factor data received for the same user, even though the data of the authentication factor itself may not be the same over multiple inputs from the user. In another case, the matrix generator 118 may first modify the authentication factor to normalize it such that multiple copies of the authentication factor received from the same user are normalized to the same output values, so long as they are within a threshold of similarity. This normalized value is then used to generate the rotation instructions using a hashing method as described above. In yet another embodiment, the matrix generator 118 may generate a template or map from the biometric data and use this template or map to generate the rotation instructions, e.g., via the hashing method described above.

After generating the rotation instructions, the matrix generator 118 rotates the cube according to the rotation instructions. The matrix generator 118 may initialize and rotate more than one “cube,” with each cube initialized to a different set of values and/or rotated using a different set of instructions, but with the initialized values and rotation instructions deterministically generated such that the same authentication factor (or similar authentication factor if it is of a biometric type) will generate the same initial values. In one embodiment, the rotation instructions include 42 distinct rotations for a 7×7×7 cube, as this results a theoretical maximum entropy for the resultant rotated cube. However, for other cube dimensions, a different number of rotations may be used to reach the maximum entropy level. Note that the size and dimensions of the cube, the number of rotations, the initialization method, and the generation of the rotation instructions may be varied for each client to ensure that no two clients have the same method of generating the rotated cube.

The matrix generator 118 stores the results of the rotation in one or more rotated cube matrices, with each rotated cube matrix corresponding to a rotated cube. These may then be transmitted to the user algorithm converter/validator 122 for further processing as described below.

In one embodiment, the matrix generator 118 also generates a factor based number based on the first authentication factor. This may be generated using a hashing function or other function that can deterministically generate the same value from the first authentication factor. As noted above, the first authentication factor may be modified before the matrix generator 118 uses it to generate the rotation instructions such that the modified first authentication factor does not change due to changes in the authentication factor data when the authentication factor comprises biometric information. This same modified first authentication factor may be used to generate the factor based number via the hashing or other function. The factor based number is transmitted by the matrix generator 118 to the user key generator/validator 120 to select, i.e., index, a system key from the system keys store 114, in order to generate a user key in combination with a username provided by the user, as described above. In one embodiment, the generation of the factor based number is performed by the user key generator/validator 120 instead.

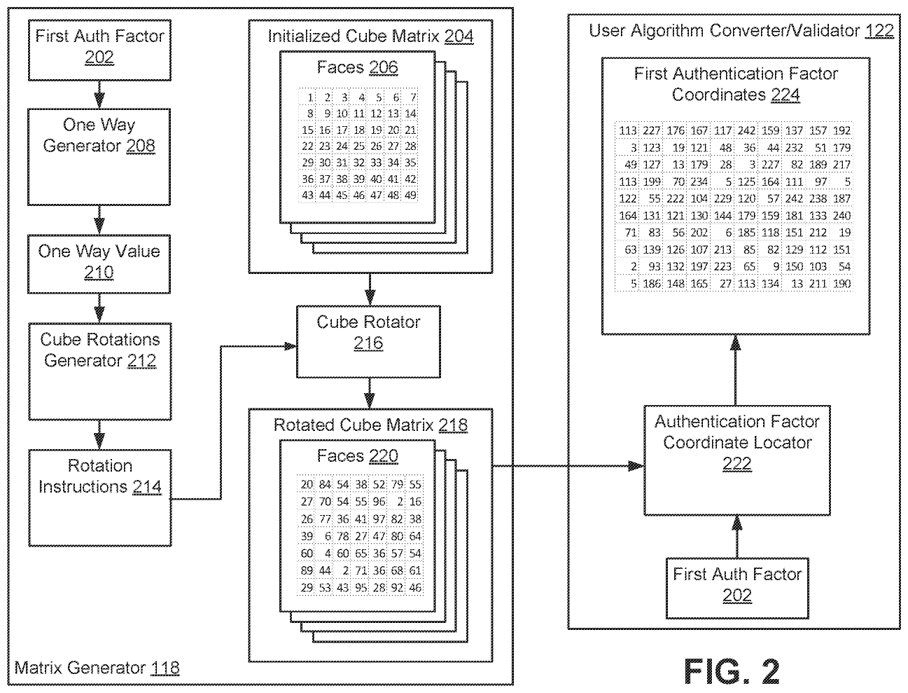

Additional details regarding the matrix generator 118 are described below with reference to FIG. 2.

The user key generator/validator 120 generates a user key using a system key indexed by the factor based number and the user provided unique username during registration of the user. Alternatively, during authentication of a user, the user key generator/validator 120 validates the username provided by the user using a stored user algorithm associated with the user and the user key for the user.

During registration, the user key generator/validator 120 receives the factor based number from the matrix generator 118, as described above, or generates the factor based number directly, using the method described above. The user key generator/validator 120 uses the factor based number as an index or lookup value to lookup/retrieve a system key from the system keys store 114. Using this system key, the user key generator/validator 120 generates a user key by applying the selected system key to the user provided username. The key may be appended to the username (along with a delimiter) and processed through a one way function, such as a hash to generate the user key. The user key generator/validator 120 passes the user key to the user algorithm converter/validator 122, which converts the user key into the user algorithm for the user.

During authentication, a similar but reverse process occurs. The user key generator/validator 120 receives the user key from the user algorithm converter/validator 122. The user key is generated on-the-fly using the stored user algorithm for the user, and is never stored. The user key generator/validator 120 also receives a factor based number for the user from the matrix generator 118. The user key generator/validator 120 uses the same one way function used during registration on the username currently provided by the user along with the selected system key that is indexed using the received factor based number to generate an unverified user key. This unverified user key is a user key that is generated using the currently provided username. The unverified user key is compared to the user key that was generated on the fly using the stored user algorithm. If a match is found, then the username check passes. Otherwise, the username check fails, and the user key generator/validator 120 may send a message to the client system link 126 indicating that the username check failed.

The user algorithm converter/validator 122 generates, during registration of the user, the user algorithm for the user based on the rotated cube matrix, the second (or additional) authentication factors provided by the user, and the user key generated by the user key generator/validator 120. During authentication of the user, the user algorithm converter/validator 122 reverses this process by retrieving the user algorithm previously generated for the user, and uses it, along with the rotated cube matrix generated using the currently provided first authentication factor, to generate a second authentication factor and a user key to compare to a second authentication factor currently provided with the user along with a user provided username.

In detail, during the registration process, the user algorithm converter/validator 122 receives at least two authentication factors from the user. The user algorithm converter/validator 122 locates the first authentication factor on the one or more rotated cube matrices generated by the matrix generator 118. To do this, the user algorithm converter/validator 122 may modify the first authentication factor similar to the method described above for the matrix generator 118, or may receive a modified first authentication factor directly from the matrix generator 118. As noted, this modified first authentication factor may be normalized and/or modified such that authentication data from the same user results in the same modified authentication factor. The user algorithm converter/validator 122 identifies the locations of values on the cube represented by the rotated cube matrix that match the values in the modified first authentication factor. For example, if the first value in the modified first authentication factor is the value 5, then the user algorithm converter/validator 122 locates the value 5 in the rotated cube matrix, and records the coordinate location of the value. After traversing the entire modified first authentication factor, the user algorithm converter/validator 122 will have generated a set of coordinate location values. The coordinate location value may identify a location on the rotated cube using a single value, or a set of values as a vector (e.g., one value for face, one for row, and one for column).

The user algorithm converter/validator 122 may modify the second authentication factor provided by the user during registration, as well as any other authentication factors provided during registration, using the same method used to modify the first authentication factor. The user algorithm converter/validator 122 may then locate the second and additional authentication factors on one or more of the rotated cube matrices generated by the matrix generator 118 and generate sets of coordinate location values for each authentication factor. The user algorithm converter/validator 122 may further generate a set of coordinate location values for the user key generated by the user key generator/validator 120, using the same process described above.

The user algorithm converter/validator 122 may then take the coordinate location value sets for the second and additional authentication factors, as well as the user key, and compare these to the coordinate value set generated for the first authentication factor. The user algorithm converter/validator 122 may determine a difference in value between the coordinate value set for first authentication factor and the coordinate value sets for the other authentication factors and the user key. These differences may be stored by the user algorithm converter/validator 122 in a user algorithm for the user in the user algorithms store 124. Alternatively, the difference values may be generated serially, i.e., difference values are generated between the coordinate location values for the first authentication factor and the coordinate location values of the user key, and then difference values are generated between the coordinate location values of the user key and the coordinate location values of the second authentication factor. Therefore, [difference 1]=[factor 1]−[user key], and [difference 2]=[factor 2]−[user key]. In this fashion, the user key and the second authentication factors are intertwined such that the second authentication factor cannot be generated without first knowing and/or generating the user key.

In another embodiment, the user algorithm converter/validator 122 does not use a simple difference between the coordinate location values but uses a different algorithm which can compare multiple values to each other to generate a result. The result should have a 1:1 relationship to the two input sets of values.

The user algorithm converter/validator 122 may additionally include in the user algorithm information regarding the date/time and/or other system data. This allows the user algorithm to become tamper-evident, as any modification of the user algorithm will cause this additional information to be modified and be incorrect. For example, the user algorithm converter/validator 122 may check a timestamp within the user algorithm to see if a last access date matches a last access date made by the user algorithm converter/validator 122. If not, the user algorithm converter/validator 122 may send a message indicating that the user algorithm may have been tampered with.

In the case of user authentication, the process described above is performed in a reverse fashion. The user algorithm converter/validator 122 receives one or more rotated cube matrices from the matrix generator 118 that are generated by a currently provided first authentication factor, which is the first authentication factor provided by the user during the authentication phase. Subsequently, the user algorithm converter/validator 122 retrieves the user algorithm for the user from the user algorithms store 124. Each user algorithm in the user algorithm store 124 may be indexed by the user's username, which the user provides during authentication. If no user algorithm for a particular username is found, the user algorithm converter/validator 122 may throw an error and send the error message to the client system link 126 to inform the client system 108 and/or the user system 104 that authentication has failed. The user algorithm converter/validator 122 may also indicate that the failure was due to an invalid username.

If the user algorithm for the user is located, the user algorithm converter/validator 122 can generate both a user key and a second authentication factor using the rotated cube matrix/matrices and the first authentication factor that the user provides. To do this, the user algorithm converter/validator 122 generates the coordinate location values for the currently provided first authentication factor, and uses the difference values (or other algorithm) in the user algorithm to generate a user key. For example, if using the above case of the serially generated difference values, the user algorithm converter/validator 122 may take the coordinate location values for the currently provided first authentication factor, and subtracts from them the first set of difference values stored in the user algorithm for the user to generate the coordinate location values of the user key (e.g., [user key]=[factor 1]−[difference 1]). With the coordinate location values of the user key, the user algorithm converter/validator 122 can locate the values of the user key in the one or more rotational cube matrices to generate the user key. The user algorithm converter/validator 122 may then transmit the user key to the user key generator/validator 120 to verify that the username generated from the user key matches the username provided by the user. As noted above, if no match exists, the authentication system 112 may send a notification indicating that authentication has failed.

If the username matches, the user algorithm converter/validator 122 is notified and continues with authentication by generating a second authentication factor using the second set of difference values stored in the user algorithm. For example, this can be done by taking the second set of difference values stored in the user algorithm, and adding the coordinate location values of the now known user key to generate the coordinate location values of the second authentication factor (e.g., [factor 2]=[difference 2]+[user key]). The user algorithm converter/validator 122 may then generate the second authentication factor in a similar fashion to the generation of the user key by looking up the coordinate location values of the second authentication factor in the rotational cube matrix. The user algorithm converter/validator 122 may convert the second authentication factor back to an unmodified state to compare to a second authentication factor currently provided by the user, or modify the second authentication factor currently provided by the user to the same format as the generated second authentication factor in order to compare the two. If the user is a valid user, then the two second authentication factors (modified or unmodified) should match. In this case, the user algorithm converter/validator 122 may send a notification to the client system link 126 that the user is authenticated/valid. However, if the user is fraudulent and has provided false authentication factors, either with the first or second authentication factors, then the generated and provided second authentication factors will not match, and the user algorithm converter/validator 122 may send a notice to the client system link 126 indicating that the user is not authenticated, and may provide a reason, e.g., that the factors do not match.

In one embodiment, the user algorithm converter/validator 122 may also accept additional authentication factors. For example, a third authentication factor may be accepted during registration, and difference values may be computed in a similar fashion for this third authentication factor. However, instead of matching this third authentication factor with a currently provided third authentication factor during authentication, the user algorithm converter/validator 122 may generate the third authentication factor using a process similar to that described above and transmit this (e.g., via the user multiple factor input receiver 116) to the user so that the user can know that the authentication system is trustworthy. Once the user verifies that the system knows the third authentication factor, the user may then transmit the second authentication factor to the authentication system 112, upon which the system may verify the second authentication factor in the manner described above. The third authentication factor may be generated from a separate rotated cube matrix rather than the rotated cube matrix used for the user key and the second authentication factor.

In another embodiment, the user only provides a single authentication factor. In such a case, the authentication factor may be split into two authentication factors, and the process proceeds according to the method described above using two authentication factors.

Additional details regarding the user algorithm converter/validator 122 are described below with reference to FIG. 2.

The client system link 126 communicates with the client system 108, and serves as a counterpart to the authentication system link 110. The results of any authentication, including any reason of failure, may be transmitted from the authentication system 112 to the client system 108 via the client system link 126. This information may also be separately logged in a log at the authentication system 112.

Furthermore, although the method and system here is described in reference to authenticating a user, in other embodiments the method and system described here can be used to verify the factors for purposes other than authentication. The authentication factors may also be referred to as identity factors in these cases. For example, a client system may necessitate the use of a user's personally identifiable and sensitive information, such as a social security number (SSN). However, the client system does not wish to store this information. Instead, the SSN may be used as an identity factor for the authentication system. A user could input a first identity factor, after which the system may generate the SSN as the second identity factor using the method described above. This sensitive data is only placed temporarily in memory for use during a session and is deleted after the session ends, preventing the data from being retrieved later on. As another example, the authentication system may be used as a fraud detection or other security mechanism. A user may be requested to verify some data, which may serve as an identity factor, to determine whether the user is legitimate, before granting access to the user.

### Example Block Diagram of Rotated Cube Matrix Generation and Coordinate Locator

FIG. 2 is an example of a method to geometrically generate a rotated cube matrix used to derive the coordinate values for the user algorithm based on user provided factors, in accordance with an embodiment. The process described in FIG. 2 illustrates the process by which a first authentication factor is used to generate a rotated cube matrix, which is subsequently used to determine coordinate location values for the first authentication factor. In contrast to methods which algebraically generate an output from an input, such as hash function, encryption function, and so on, the method described herein generates a scrambled result from the first authentication factor using a geometric-spatial method, which may allow for greater entropy and further allows for the means to “entangle” multiple authentication factors to the user algorithm, while not allowing any authentication factor to be recoverable via malicious access to the user algorithm.

As illustrated, a first user authentication factor 202 received from the user is sent to a one way generator 208, which generates the one way value 210. This one way value 210 is subsequently sent to the cube rotations generator 212. As described above, each element in the one way value 210 may correspond to a different rotation instruction. The cube rotations generator 212 generates the rotation instructions 214, which are transmitted to the cube rotator 216. The cube rotator receives the initialized cube matrix 204, which may be initialized according to the process described above. The initialized cube matrix 204 may include multiple sub-matrices, each representing a face 206 of the initialized cube matrix 204. Alternatively, these sub-matrices may be combined into a single larger matrix, array, or other data structure. Upon receipt of the rotation instructions 214, the cube rotator 216 rotates the initialized cube matrix 204 according to the instructions. The rotation emulates the rotations observed in a 3D combination puzzle cube, where each element of each of the faces 206 represents an individual surface on the 3D puzzle cube. For each rotation instruction 214, the cube rotator 216 moves the values within the initialized cube matrix 204 such that the resulting values represent the 3D puzzle cube were the rotations applied to the cube. After applying all the rotation instructions, the result is the rotated cube matrix 218, with the faces 220 that have values that differ from those of the initialized cube matrix 204.

In some embodiments, instead of a cube, the matrix generator 118 may initialize a different representation, such as a four dimensional “cube” (i.e., a tesseract). Such an object would be represented using additional matrices for the additional faces of the object. For example, a tesseract has 24 faces, and thus each of these faces may be represented by a different matrix, or a single matrix or data structure may be used to represent the 24 faces. A rotation using this tesseract representation would follow rules for rotating a 4D combination puzzle (e.g., a 4D Rubik's Cube). Thus, additional types of rotation instructions may be used to rotate the 4D layers of the tesseract. In addition, locating a value on the tesseract may require additional coordinate values. For example, while a 3D cube might require a value for the face, row, and column, a coordinate location for a 4D cube may require four values for each of the dimensions.

After generating the rotated cube matrix 218, the matrix generator 118 sends the rotated cube matrix 218 to the user algorithm converter/validator 122. The user algorithm converter/validator 122 may have an authentication factor coordinate locator 222 that receives the first authentication factor 202 and, for each value in the first authentication factor 202 (e.g., for each character or digit), the authentication factor coordinate locator 222 finds the location of a matching value in the rotated cube matrix 218. The coordinates of this location, along with the other locations of the other values in the first authentication factor, are then generated and used in subsequent steps as described above to generate the user algorithm during registration or to generate the other factors and/or user key during authentication.

### Example Registration and Authentication Scenarios

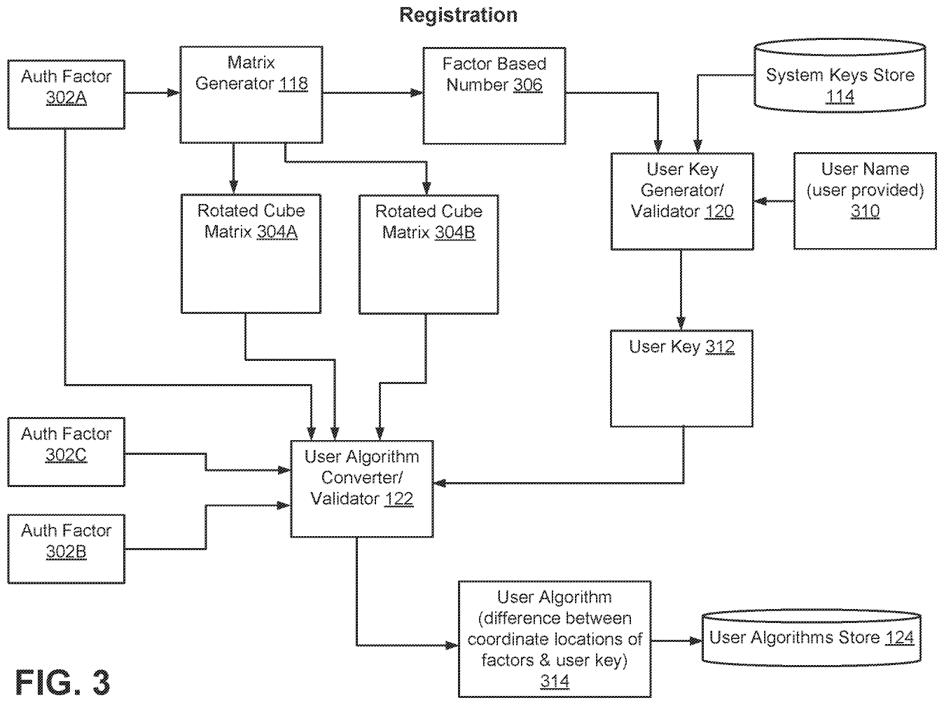

FIG. 3 illustrates an example of user registration using the method described herein, in accordance with an embodiment. As illustrated a first authentication factor 302A is received and sent to the matrix generator 118 and the user algorithm converter/validator 122. The matrix generator 118 generates the rotated cube matrices 304A-B, which are sent to the user algorithm converter/validator 122. In addition, the matrix generator 118 generates the factor based number 306 which is sent to the user key generator/validator 120, which selects a system key from the system keys store 114, and along with the user provided username 310, generates the user key 312 as described previously. The user key 312 is sent to the user algorithm converter/validator 122, and along with the authentication factors 302A-302C, a user algorithm 314 is generated and stored in the user algorithms store 124, as described above. As described above, the user algorithm 314 indicates the differences between coordinate location values of each of the authentication factors 302A-C and the user key 312 as located on the one or more rotated cube matrices 304A-B.

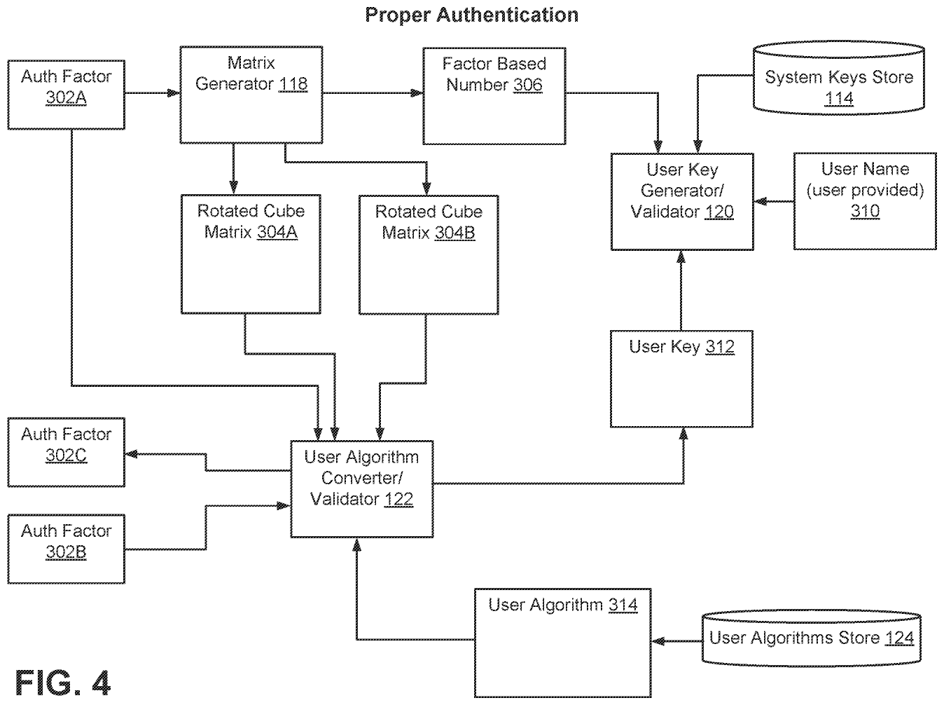

In the example illustrated here and in the other examples illustrated in FIGS. 4-7, the authentication factors may be modified/standardized before being used by the elements that are shown, as described above. This allows authentication factors which may change slightly across different inputs, such as biometric information, to be used to generate the same matrices or coordinate location values each time.

FIG. 4 illustrates an example of a proper user authentication using the method described herein, in accordance with an embodiment. After registration of the user as described above with reference to FIG. 3, user authentication occurs when a user provides the first authentication factor 302A to the authentication system 112. The authentication factor 302A is sent to the matrix generator 118 to generate the rotated cube matrices 304A-B and the factor based number 306. The authentication factor 302A is sent to the user algorithm converter/validator 122, which accesses the user algorithm 314 for the user and uses the user algorithm 314 and the first authentication factor 302A to generate the user key 312. The user key 312 is sent to the user key generator/validator 120 to validate the username 310 provided by the user, as described above.

If the username is verified, the user algorithm converter/validator 122 generates the second authentication factor and compares it to the second authentication factor 302B provided by the user. If a match is found, the user is deemed to be authenticated. Otherwise, user authentication fails.

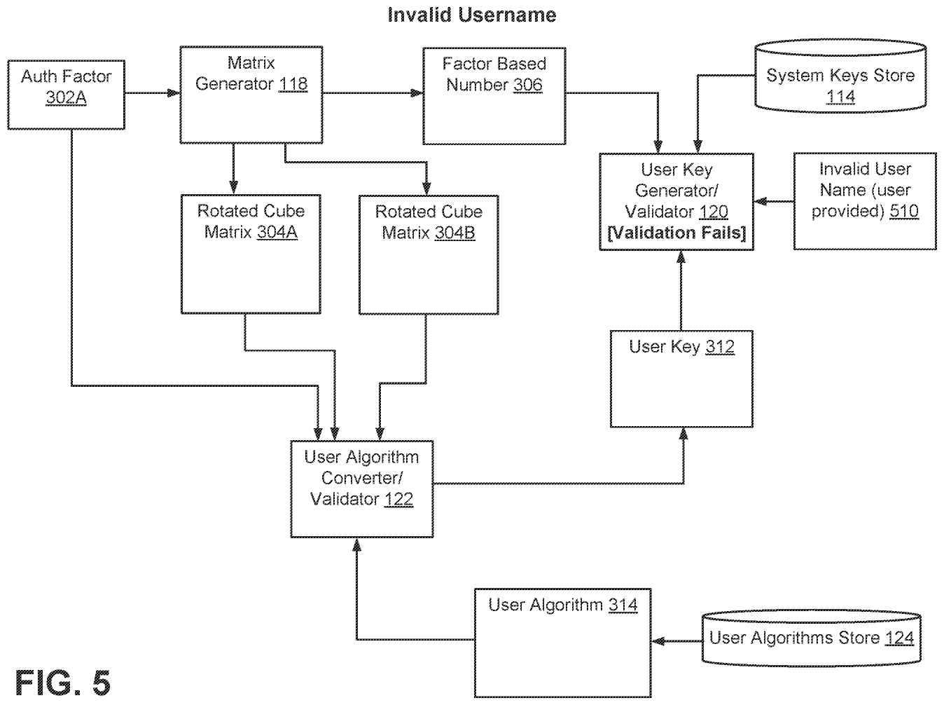

FIG. 5 illustrates an example of a failed authentication due to an invalid username using the method described herein, in accordance with an embodiment. The authentication process shown in FIG. 5 is similar to that in FIG. 4. However, unlike in FIG. 4, when the user key 312 is transmitted to the user key generator/validator 120, the user key generator/validator 120 cannot validate the user as the provided username 910 is invalid and does not pass the verification process of the user key generator/validator 120 as described above. For example, the user key generator/validator 120 may generate the username using the user key 312 and the system key retrieved using the factor based number 306. After generating the username, the user key generator/validator 120 determines that it does not match the invalid username 510 provided by the user. After determining that the username is invalid, the user key generator/validator 120 sends a message indicating that username validation fails. Since username validation has valid, the validation process stops, and the process related to generating the additional authentication factors are not executed.

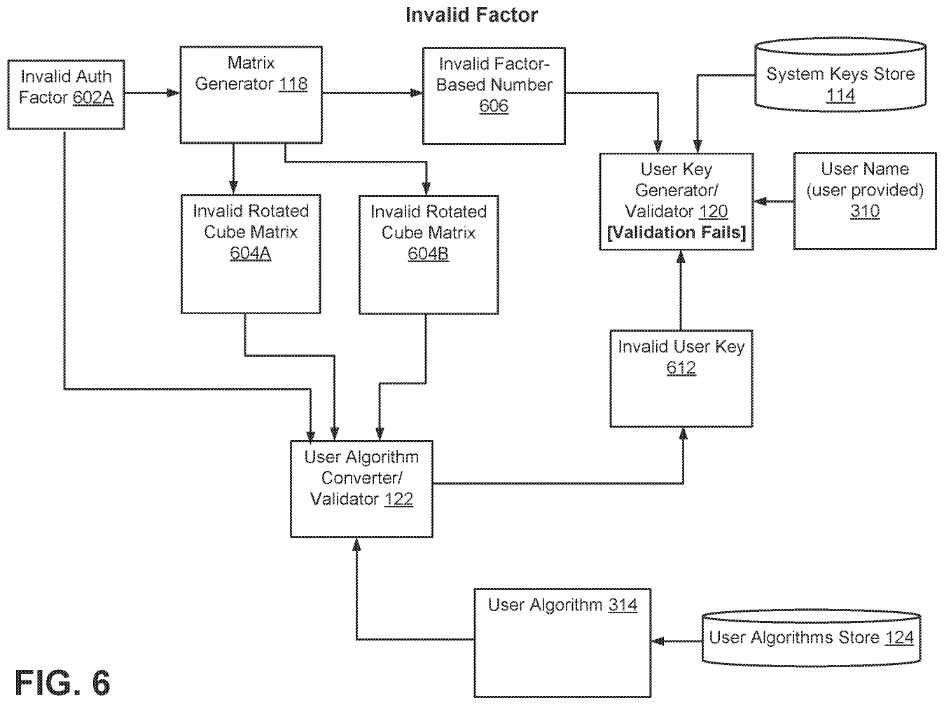

FIG. 6 illustrates an example of a failed authentication due to an invalid factor using the method described herein, in accordance with an embodiment. The process illustrated in FIG. 6 is similar to that in FIG. 4, however the authentication factor 602A provided by the user is invalid, and does not match the original authentication factor provided by the user during registration. In this case, the matrix generator 118 will generate invalid rotated cube matrices 604A-B, and thus the user algorithm converter/validator 122 will also generate an invalid user key 612. This will cause validation of the username to fail. At this point, similar to the process in FIG. 5, the authentication process ceases and the authentication system 112 sends a notice indicating that the authentication is failed.

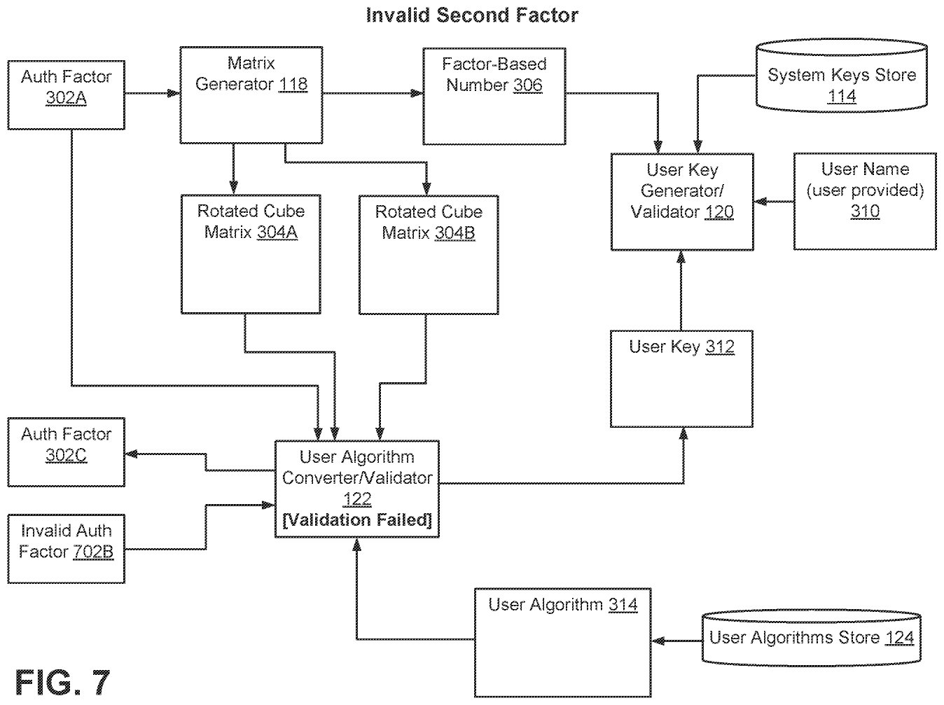

FIG. 7 illustrates an example of a failed authentication due to an invalid second factor using the method described herein, in accordance with an embodiment. The process illustrated in FIG. 7 is similar to that in FIG. 4, however, in this case the second authentication factor 702B is invalid. In such a case, after the user algorithm converter/validator 122 generates the second authentication factor, it will determine that it does not match the second authentication factor 702B provided by the user. At this point, the authentication process fails and the authentication system 112 sends a notice indicating failure to verify the second authentication factor.

### Example Process for Identifying Remote Objects

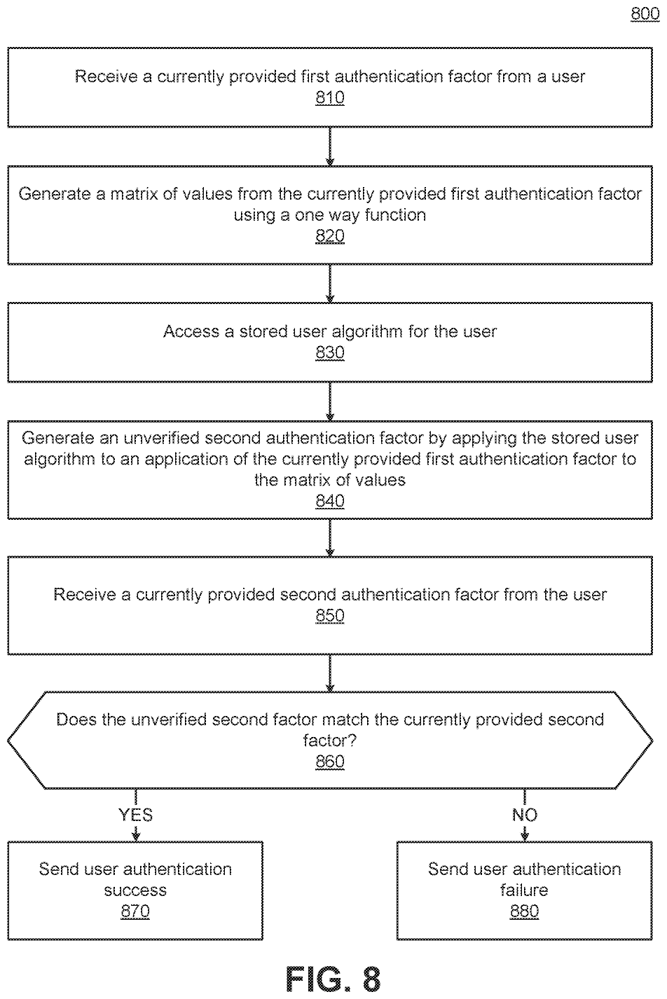

FIG. 8 is a flow diagram illustrating a process for multiple factor authentication without storing any factors, in accordance with an embodiment. In some example embodiments, the process may have different and/or additional steps than those described in conjunction with FIG. 8. Steps of the process may be performed in different orders than the order described in conjunction with FIG. 8. Some steps may be executed in parallel. Alternatively, some of the steps may be executed in parallel and some steps executed sequentially. Alternatively, some steps may execute in a pipelined fashion such that execution of a step is started before the execution of a previous step. In one embodiment, the process is performed by the authentication system 112.

The authentication system 112 initially receives 810 a currently provided first authentication factor from the user. This may be similar to the authentication factor 302A. The authentication system 112 generates 820 a matrix of values from the first authentication factor using a one way function. This may be similar to the process described above for the matrix generator 118 for generating the rotated cube matrix/matrices, such as the rotated cube matrices 304A-B.

The authentication system 112 accesses 830 a stored user algorithm for the user, as described above. This may be similar to user algorithm 314. After retrieving the user algorithm, the authentication system 112 generates 840 an unverified second authentication factor using the stored user algorithm and the currently provided first authentication factor. This may be similar to the process described above for the user algorithm converter/validator 122. The second authentication factor is unverified because it is not known at generation time whether it matches the originally provided second authentication factor provided during registration. Optionally, the authentication system 112 may also validate a username using a user key as described above.

The authentication system 112 receives 850 a currently provided authentication factor from the user. This may correspond to the authentication factor 302B. The authentication system 112 determines 860 if the unverified second factor matches the currently provided second authentication factor that was provided by the user. If a match is found, then the authentication system 112 sends 870 a message indicating authentication success. Otherwise, the authentication system 112 sends 880 a message indicating authentication failure.

### Example Machine Architecture

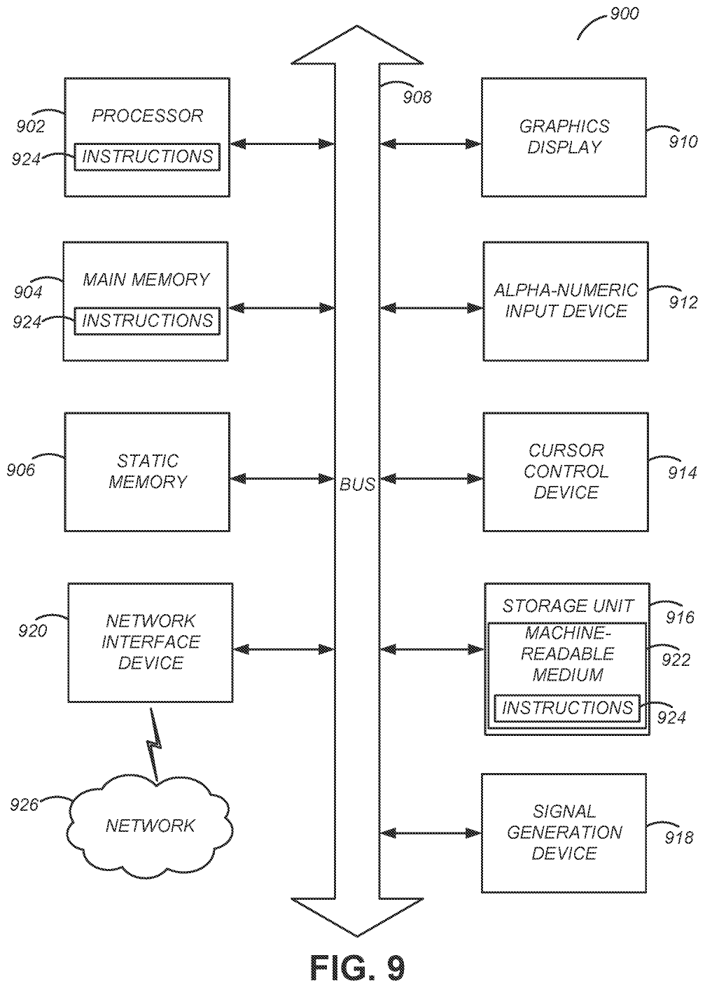

FIG. 9 is a block diagram illustrating components of an example machine able to read instructions from a machine-readable medium and execute them in a processor or controller, according to an embodiment. Specifically, FIG. 5 shows a diagrammatic representation of a machine in the example form of a computer system 900. The computer system 900 can be used to execute instructions 924 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment. It is noted the instructions correspond to the functionality of components and/or processes described herein, for example, with respect to the above figures.

The machine may be a server computer, a client computer, a personal computer (PC), a tablet PC, a set-top box (STB), a smartphone, an internet of things (IoT) appliance, a network router, switch or bridge, or any machine capable of executing instructions 924 (sequential or otherwise) that specify actions to be taken by that machine. Further, while only a single machine is illustrated, the term “machine” shall also be taken to include any collection of machines that individually or jointly execute instructions 924 to perform any one or more of the methodologies discussed herein.

The example computer system 900 includes one or more processing units (generally processor 902). The processor 902 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 900 also includes a main memory 904. The computer system may include a storage unit 916. The processor 902, memory 904 and the storage unit 916 communicate via a bus 908.

In addition, the computer system 900 can include a static memory 906, a display driver 910 (e.g., to drive a plasma display panel (PDP), a liquid crystal display (LCD), or a projector). The computer system 900 may also include alphanumeric input device 912 (e.g., a keyboard), a cursor control device 914 (e.g., a mouse, a trackball, a joystick, a motion sensor, or ther pointing instrument), a signal generation device 918 (e.g., a speaker), and a network interface device 920, which also are configured to communicate via the bus 908.

The storage unit 916 includes a machine-readable medium 922 on which is stored instructions 924 (e.g., software) embodying any one or more of the methodologies or functions described herein. The instructions 924 may also reside, completely or at least partially, within the main memory 904 or within the processor 902 (e.g., within a processor's cache memory) during execution thereof by the computer system 900, the main memory 904 and the processor 902 also constituting machine-readable media. The instructions 924 may be transmitted or received over a network 926 via the network interface device 920.

While machine-readable medium 922 is shown in an example embodiment to be a single medium, the term “machine-readable medium” should be taken to include a single medium or multiple media (e.g., a centralized or distributed database, or associated caches and servers) able to store the instructions 924. The term “machine-readable medium” shall also be taken to include any medium that is capable of storing instructions 924 for execution by the machine and that cause the machine to perform any one or more of the methodologies disclosed herein. The term “machine-readable medium” includes, but not be limited to, data repositories in the form of solid-state memories, optical media, and magnetic media. It is noted that in some example embodiments, the core components of the computer system may disregard components except for the processor 902, memory 904, and bus 908 and may in other embodiments also include the storage unit 916 and/or the network interface device 920.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated and described with the figures above. Modules may constitute either software modules (e.g., code embodied on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 902, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APis).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the claimed invention. This description should be read to include one or at least one and the singular also includes the plural unless it is obvious that it is meant otherwise.

Upon reading this disclosure, those of skill in the art will appreciate still additional alternative structural and functional designs for the system described above. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method, comprising:
receiving a currently provided first identity factor from a user;
generating a matrix of values from the currently provided first identity factor;
accessing a stored user algorithm for the user;
applying the stored user algorithm to an application of the currently provided first identity factor to a non-stored verified matrix of values to generate an unverified second identity factor;
receiving a currently provided second identity factor from the user; and
determining whether the unverified second identity factor matches the currently provided second identity factor.

2. The method of claim 1, wherein generating the matrix of values comprises using an one way function.

3. The method of claim 1, wherein, prior to accessing the stored user algorithm, generating the stored user algorithm by comparing an application of a non-stored verified first identity factor to the non-stored verified matrix of values with an application of a non-stored verified second identity factor to the non-stored verified matrix of values.

4. The method of claim 3, wherein the non-stored verified matrix of values is generated from the non-stored verified first identity factor using an one way function during a registration phase.

5. The method of claim 3, wherein generating the stored user algorithm is performed during a registration phase.

6. The method of claim 1, further comprising in response to determining that the unverified second identity factor matches the currently provided second identity factor, transmitting a valid authentication response for the user.

7. The method of claim 1, further comprising in response to determining that the unverified second identity factor does not match the currently provided second identity factor, transmitting an invalid authentication response for the user.

8. A system, comprising:
a user system of a user;
a client system of an entity; and
an authentication system configured to:
receive a currently provided first identity factor from the user via the user system;
generate a matrix of values from the currently provided first identity factor using an one way function;
access a stored user algorithm for the user;
apply the stored user algorithm to an application of the currently provided first identity factor to a non-stored verified matrix of values to generate an unverified second identity factor;
receive a currently provided second identity factor from the user; and
determine whether the unverified second identity factor matches the currently provided second identity factor.

9. The system of claim 8, wherein the currently provided first identity factor comprises a password or biometric data.

10. The system of claim 8, wherein the client system is accessible by the user system after authentication of the user.

11. The system of claim 8, wherein the stored user algorithm is generated during a registration phase by comparing an application of a non-stored verified second identity factor to the non-stored verified matrix of values with an application of a non-stored verified second identity factor to the non-stored verified matrix of values.

12. The system of claim 11, wherein the non-stored verified matrix of values is generated from the non-stored verified first identity factor using an one way function during the registration phase.

13. The system of claim 8, wherein the authentication system is further configured to transmit a valid authentication response for the user to the client system when the unverified second identity factor matches the currently provided second identity factor.

14. The system of claim 8, wherein the authentication system is further configured to transmitting an invalid authentication response for the user to the client system when the unverified second identity factor does not match the currently provided second identity factor.

15. A method, comprising:
receiving a currently provided first identity factor from a user;
generating a matrix of values from the currently provided first identity factor using a one way function;
accessing a stored user algorithm for the user, the stored user algorithm previously generated during a registration phase by comparing an application of a non-stored verified second identity factor to a non-stored verified matrix of values with an application of a non-stored verified first identity factor to the non-stored verified matrix of values;
generating an unverified second identity factor by applying the stored user algorithm to an application of the currently provided first identity factor to the matrix of values;
receiving a currently provided second identity factor from the user;
determining whether the unverified second factor matches the currently provided second factor.

16. The method of claim 15, further comprising in response to determining that the unverified second identity factor matches the currently provided second identity factor, transmitting a valid authentication response for the user.

17. The method of claim 15, further comprising in response to determining that the unverified second identity factor does not match the currently provided second identity factor, transmitting an invalid authentication response for the user.

18. The method of claim 15, wherein the non-stored verified matrix of values is generated from the non-stored verified first identity factor using an one way function during a registration phase.

19. The method of claim 15, receiving the currently provided first identity factor comprises collecting biometric data from the user.

20. The method of claim 15, receiving the currently provided first identity factor comprises receiving a password from the user.
